(19) United States
(12) Patent Application Publication
(10) Pub. No.: US 2015/0106135 A1
(43) Pub. Date: Apr. 16, 2015

(54) BOOKING DECISION METHOD FOR TRANSPORTATION INDUSTRY BY SAMPLING OPTIMAL REVENUE

(71) Applicant: National Tsing Hua University, Hsinchu (TW)

(72) Inventors: Yi-Feng HUNG, Hsinchu (TW); Wei-Shan NI, Hsinchu (TW)

(73) Assignee: National Tsing Hua University, Hsinchu (TW)

(21) Appl. No.: 14/226,551

(22) Filed: Mar. 26, 2014

(30) Foreign Application Priority Data
Oct. 15, 2013 (TW) 102137098

(51) Int. Cl. G06Q 10/02; G06Q 50/14

(52) U.S. Cl. CPC G06Q 10/02; G06Q 50/14
USPC 705/5

(57) ABSTRACT

In a booking decision method for transportation industry by sampling optimal revenues, a random sample scenario of a scenario index is generated. A first optimal revenue is generated under a condition of rejecting the current arrival booking request, and a second optimal revenue is generated under a condition of accepting the current arrival booking request. The scenario index is increased by 1 if the sample scenario index is smaller than a total number of sample scenarios; otherwise, a first average revenue of the first optimal revenue and a second average revenue of the second optimal revenue are calculated, and the marginal profit is calculated according to the first average revenue and the second average revenue. If the price of a current arrival request is greater than or equal to the marginal profit, the current arrival booking request is accepted; otherwise, the current arrival booking request is rejected.

### BACKGROUND OF THE INVENTION

1. Field of the Invention

The present invention relates to the technical field of seat booking and, more particularly, to a booking decision method for transportation industry by sampling optimal revenue.

2. Description of Related Art

Transportation industry, e.g. airline, railway, bus company, and so on, is a capacity constrained service industry with the objective of maximizing revenue. A booking horizon of a scheduled service route between two points is the time interval between the current time and the departure time of the service. Customer reservations for a scheduled service route between two points arrive randomly during its reservation horizon. The desired service route, the departure time, and the number of seats will be specified by a customer when making the reservation. The available seats of a transportation apparatus are limited. It is imperative for a transportation company to make an immediate response of whether to accept or reject the reservation when a customer booking request arrives. The company may reject a reservation request with a lower price and save the seats for future customers who are willing to pay a higher price. However, a rejection may cause the seats to be empty when the transportation apparatus departs and there is no customer who pays a higher price for the seats, resulting in wasted seats and no generated revenue. Thus, it is desired to improve the conventional booking methods.

### SUMMARY OF THE INVENTION

The object of the invention is to provide a booking decision method for transportation industry by sampling optimal revenue, which can be applied in seats booking of the transportation companies to determine whether to accept or reject a booking request in real time, so as to possess an excellent estimation of future thereby maximizing the revenue of the company.

In one aspect of the invention, there is provided a booking decision method for transportation industry by sampling optimal revenue, which is executed on a computer system for a transportation company to determine whether to accept or reject a current arrival booking request. The computer system includes an input module, a database module, an output module, and a processor module. The input module receives the current arrival booking request. The database module is used to store data. The processor module is coupled to the input module, the database module, the output module, and the processor module to execute the booking decision method for transportation industry by sampling optimal revenues, and to output executed result to the output module. The method comprises the steps of: (A) the processor module initializing a sample scenario index y=1; (B) the processor module generating random sample; (C) the processor module generating a first optimal revenue r_{y} under a condition of rejecting the current arrival booking request, and generating a second optimal revenue r_{y}′ under a condition of accepting the current arrival booking request; (D) the processor determining whether the sample scenario index is smaller than a total number of sample scenarios Y and, if yes, increasing the sample scenario index by 1 and then returning to step (B); (E) if the sample scenario index is determined to be not smaller than the total number of sample scenarios Y in step (D), calculating a first average revenue r̅ of the first optimal revenue r_{y} and a second average revenue r̅′ of the second optimal revenue r_{y}′, and calculating the marginal profit mⱼ_{⁰}ₚ_{⁰}ᵤ_{⁰} according to the first average revenue and the second average revenue; and (F) the processor module determining whether a price is greater than/equal to the marginal profit and, if yes, the processor module accepting the current arrival booking request, if no, rejecting the current arrival booking request.

In another aspect, there is a provided booking decision method for transportation industry by sampling optimal revenue, which is executed on a computer system for a transportation company. The computer system includes an input module, a database module, an output module, and a processor module. The input module receives an arrival booking request. The database module is used to store data. The processor is coupled to the input module, the database module and the output module to execute the booking decision method for transportation industry by sampling optimal revenues, and to output executed result to the output module. The method comprises the steps of (A) the processor module initializing a service route index u=1; (B) the processor module initializing a seat class j=1; (C) the processor module initializing a sample scenario index (y=1); (D) the processor module generating a random sample of the sample scenario index; (E) the processor module generating a first optimal revenue r_{y} under a condition of rejecting the booking request, and generating a second optimal revenue r_{y}′ under a condition of accepting the current booking request; (F) the processor module determining whether the sample scenario index is smaller than a total number of sample scenarios Y and, if yes, increasing the sample scenario index y by 1, and then returning to step (D); (G) if the sample scenario index is determined to be not smaller than the total number of sample scenarios in step (F), the processor module calculating a first average revenue r̅ of the first optimal revenue r_{y} and a second average revenue r̅′ of the second optimal revenue r_{y}′, and further calculating a marginal profit mⱼᵤ in accordance with the first average revenue r̅ and the second average revenue r̅′; (H) the processor module determining whether the seat class j is smaller than a number of seat class j and, if yes, increasing the seat class j by 1 and then returning to step (C); and (I) if the seat class j is determined to be not smaller than the number of seat class j in step (H), the processor module then determining whether the service route index u is smaller than a total number of service routes U and, if yes, increasing the service route index u by 1, and returning to step (B), if no, ending the execution

In still another aspect of the invention, there is a provided booking decision method for transportation industry by sampling optimal revenues, which is executed on a computer system for a transportation company. The computer system includes an input module, a database module, an output module, and a processor module. The input module receives an arrival booking request. The database module is used to store data. The processor is coupled to the input module, the database module, and the output module to execute the booking decision method for transportation industry by sampling optimal revenues, and to output executed result to the output module. The method comprises the steps of: (A) the processor module initializing a service route index u=1; (B) the processor module initializing a seat class j=1; (C) the processor module initializing an index k=1 for additional booking request of one seat; (D) the processor module initializing a sample scenario index (y=1); (E) the processor module generating a random sample scenario of the sample scenario index; (F) the processor module generating a first optimal revenue r_{y} under a condition of rejecting the booking request and generating a second optimal revenue r_{y}′ under a condition of accepting the booking request; (G) the processor module determining whether the sample scenario index is smaller than a total number of sample scenarios Y and, if yes, the processor module increasing the sample scenario by 1, and returning to step (E); (H) if the sample scenario index is determined to be not smaller than the total number of sample scenarios in step (G), the processor module calculating a first average revenue r̅ of the first optimal revenue r_{y} and a second average revenue r̅′ of the second optimal revenue r_{y}′, and further calculating a marginal profit mⱼᵤₖ in accordance with the first average revenuer and the second average revenue r̅′; (I) the processor module determining whether the marginal profit mⱼᵤₖ is smaller than a previous marginal profit mⱼᵤₖ₋₁ and, if no, the processor module increasing the index k for additional booking request of one seat by 1, and returning to step (D); (J) if the marginal profit mⱼᵤₖ is determined to be smaller than the previous marginal profit mⱼᵤₖ₋₁ in step (I), the processor module then determining whether the seat class j is smaller than a number of seat class j and, if yes, the processor module increasing the seat class j by 1, and returning to step (C); and (K) if the seat class j is determined to be not smaller than the total number of seat class j in step (J), the processor module then determining whether the service route index u is smaller than the total number of service routes U and, if yes, the processor module increasing the service route index u by 1, and returning to step (B); if in step (K), the service route u is determined not to be smaller than the total number of service routes U, ending the execution.

Other objects, advantages, and novel features of the invention will become more apparent from the following detailed description when taken in conjunction with the accompanying drawings.

### BRIEF DESCRIPTION OF THE DRAWINGS

FIG. 1 is a flowchart of the booking decision method for transportation industry by sampling optimal revenues according to an embodiment of the invention;

FIG. 2 is a schematic diagram of a computer system according to the invention;

FIG. 3 is a schematic diagram of transportation legs according to the invention;

FIG. 4 is a schematic diagram of a service route according to the invention;

FIG. 5 is a schematic diagram of a network for illustrating service route trade-oft

FIG. 6 is a schematic diagram of the final statuses of an accepted booking request and their corresponding random number ranges according to the invention;

FIG. 7 is a schematic diagram of the probability density function ƒⱼₚᵤ(τ) of the continuous random variable Vⱼₚᵤ according to the invention;

FIG. 8 is a schematic diagram of final status of already accepted booking requests and their corresponding random number ranges according to the invention;

FIG. 9 is a schematic diagram of the price classes of a current booking request and their corresponding random number ranges according to the invention;

FIG. 10 is a schematic diagram of multiple service legs according to the invention;

FIG. 11 is a schematic diagram of the information of service legs in FIG. 10;

FIG. 12 is a schematic diagram of the information of service routes in FIG. 10;

FIG. 13 is the flowchart of the booking decision method for transportation industry by sampling optimal revenues according to another embodiment of the invention;

FIG. 14 is the flowchart of the booking decision method for transportation industry by sampling optimal revenue according to still another embodiment of the invention;

FIG. 15 is a schematic diagram of time intervals according to the invention;

FIG. 16 is a schematic diagram of the curve of function pⱼᵤ(k) according to the invention.

### DETAILED DESCRIPTION OF THE PREFERRED EMBODIMENT

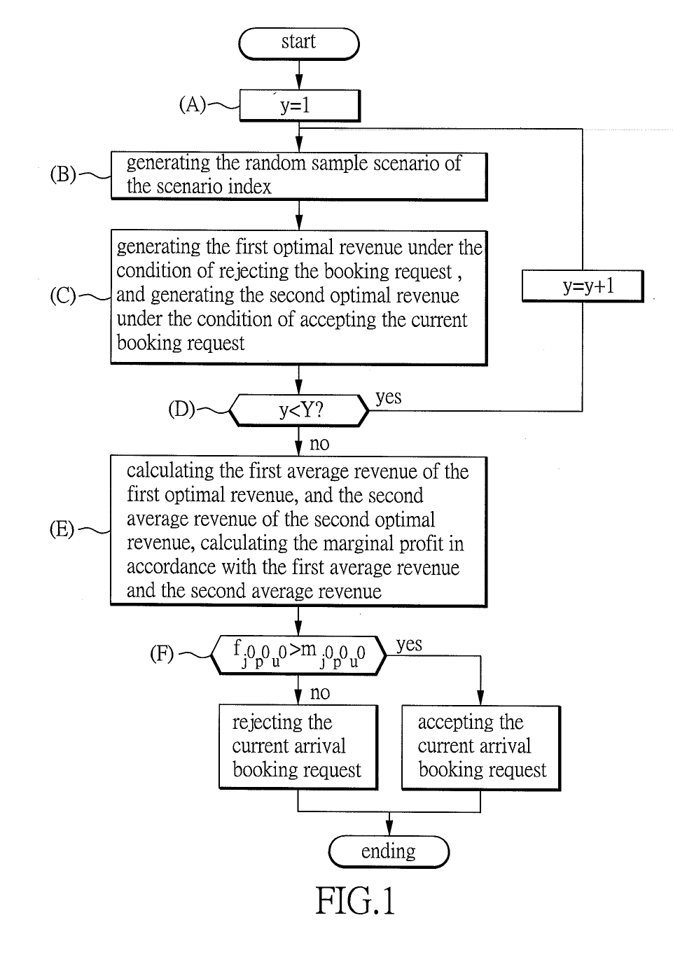

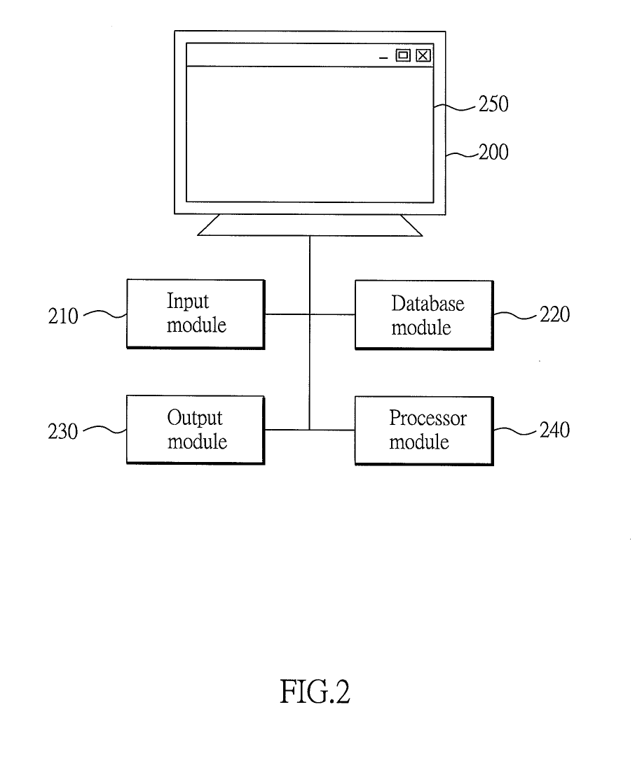

FIG. 1 is a flowchart of the booking decision method for transportation industry by sampling optimal revenue according to an embodiment of the invention. The method is executed on a computer system for a transportation company to determine whether to accept or reject a current arrival booking request based on a marginal profit. FIG. 2 is a schematic diagram of the computer system according to the invention. The computer system 200 includes an input module 210, a database module 220, an output module 230, and a processor module 240. The input module 210 receives the arrival booking request. The database module 220 is used to store data, the processor module 240 is coupled to the input module 210, the database module 220, and the output module 230 to execute the booking decision method for transportation industry by sampling optimal revenue, and to output executed result to the output module 230 for being displayed on a display screen 250.

Regarding to the description the invention, certain related basic theories and technical terms are first introduced, and then the booking decision method for transportation industry by sampling optimal revenue according to the invention is described.

The technical terms used in the invention are defined as follows:

Booking request: A customer will request a transportation company to make reservations regarding to a number of seats, seat classes, price classes, and service routes.

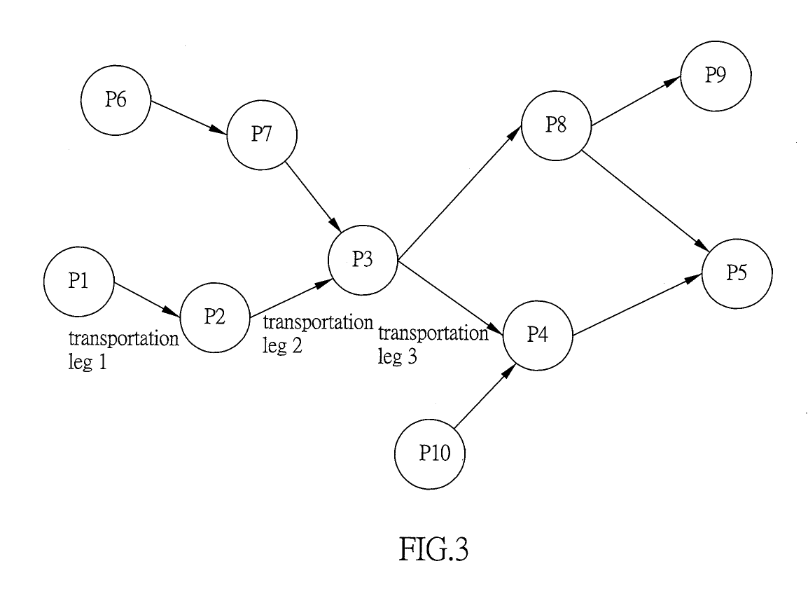

Transportation network: A transportation company normally provides services between any two points within its transportation network. A path connected two points without transfer point in between is called transportation leg. A transportation leg means that the service between the two points is provided, but without specifying service times. FIG. 3 is a schematic diagram of transportation legs in the invention. Customers can use the service of the company to travel from P1 to P4 through the transfer point P2 and P3 by taking the services on transportation legs 1, 2, and 3.

Service leg: A service leg represents a one-time service provided by a transportation apparatus that it departs at a specific time and travel on a transportation leg. According to the schedule offered by the company, a number of services on a transportation leg will depart at various times in the future. Therefore, a transportation leg corresponds to multiple service legs.

Departure time: A departure time of a service leg represents the start time of a transportation apparatus travelling from one point to another one on the transportation leg.

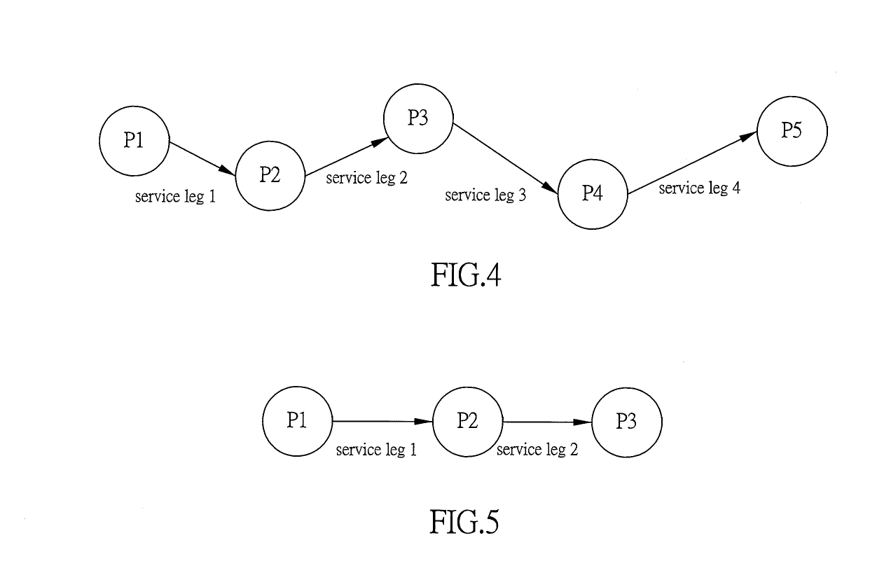

Service route: A service route represents a set of service legs that provide customer's service between two points on the transportation network. FIG. 4 is a schematic diagram of a service route in the invention. As shown in FIG. 4, the transportation service from P1 to P3 starting at a specific departure time is a service route that consists of service legs 1 and 2. That is, a customer who departs at P1 can take service leg 1 to P2 at a scheduled departure time, and then can take service leg 2 to P3 at a scheduled departure time. A single-leg service route is a service route, on which there is only one service leg. A multiple-leg service route is a service route that consists of more than one service leg. When a customer takes a multiple-leg service route, at least one transfer point between origin and destination is necessary. A multiple-leg service route in a complex transportation network is considered in the present invention. FIG. 4 shows an example of a portion of transportation service network. The service route from P1 to P5 is a multiple-leg service route containing service legs 1, 2, 3, and 4.

FIG. 5 is a schematic diagram of a trade-off decision on the network according to the invention. As shown in FIG. 5, there are three points, and three service routes related to customer services. Some customers take service route 1 (from P1 to P2) that only consists of service leg 1; some take service route 2 (from P2 to P3) that only consists of service leg 2; and some take service route 3 (from P1 to P2, then transfer at P2 to P3) that consists of service legs 1 and 2 (through transfer point P2). The result of accepting a booking request for service route 1 (consisting of service leg 1) may result in no capacity for the future demand for service route 3 (consisting of both service legs 1 and 2) that normally generates higher profit than a service route 1 (service leg 1). In addition, committing too many seats at service route 1 to customers at early stage may result in empty seats on service leg 2 due to no available seat on service leg 1 for service route 3. Therefore, for different booking requests randomly arriving in the future, the invention is necessary to optimally allocate the limited seats.

Booking request class: Booking requests are classified based on service routes, seat classes, and the price classes that customers are willing to pay for.

Cancellation status: An accepted booking request may be cancelled before the departure time.

Show status or no-show status: At the departure time, a customer having an accepted booking request may show up or not show up at departure time of a transportation service.

Final status: A final status of an already accepted request is unknown until the departure time or being cancelled. Thus, there are three possible final statuses for an already accepted request: cancellation status, show status, or no-show status.

Overbooking: Because an already accepted booking request may be cancelled before the departure time, or the customer with an already accepted booking request does not show up at the departure time, a transportation company could accept more requests than the total available seats to avoid empty seats at departure time and to maximize profit.

However, due to overbooking practices, at departure time, the number of show-up customers may be more than the available seats, some accepted customers may have no seat; thus, the transportation company has to compensate the customers or arrange the customers to another transportation service at a higher cost.

Reservation deadline: The reservation for a service route has a deadline, which is normally the departure time.

Multiple price classes: Different customers may be willing to pay different prices for the same seat class; therefore, a seat class may consist of a number of price classes.

Multiple-service booking request: A customer may request more than one service route in one inquiry. A booking request may consist of a number of services which may be different seat classes, different price classes, and different service routes.

Arrival random process: The number of future booking requests is described based on a known probability distribution (for example, normal distribution, Poisson distribution) or a known random process (for example, non-homogeneous Poisson process, Poisson distribution).

After defining the terms, some parameters used in the invention are discussed as follows:

Data_{—}1: Random description of future arrival booking requests including the distribution and arrival rate of customers in each seat class, each price class, and each service route. In addition, probabilities of cancellation status and no-show status of an accepted request are also specified.

Data_{—}2: This is a deterministic sample scenario of a future booking request. A deterministic sample scenario specifies the completeness and deterministic information of all future booking requests. More specifically, a sample scenario specifies the following parameters:

(1) the number of requests;

(2) the seat class, the price class, and the service route of each request; and

(3) the final status of each request (cancellation status, show status, or no-show status).

The data in Data_{—}2 is a part of a complete sample scenario.

Data_{—}3: The number of current already accepted booking requests of each request class (seat class, price class, and service route).

Data_{—}4: Final status of current already accepted booking requests. That is, each booking request class (seat class, price class, and service route), the number of already accepted booking requests that will be cancelled, the number of customers that will show up, and the number of customers that will not show up are specified. This is only partial information of a complete sample scenario.

Data_{—}5: A current booking request with known request classes (seat class, price class, and service route). Whether the current booking request will be cancelled, will show up, or will not show up is unknown at the reservation time.

Data_{—}6: The final status (cancellation status, show status, and no-show status) of a current booking request with known seat class, price class, and service route is specified. This is only partial information of a complete sample scenario.

Data_{—}7: A current booking request with known seat class and service route. The price class and the final status (cancellation status, show status, and no-show status) of the request are unknown at a module calculation time.

Data_{—}8: The price class and final status (cancellation status, show status, and no-show status) of a booking request. This is only partial information of a complete sample scenario.

Data_{—}9: The optimal revenue under the condition of accepting the booking request.

Data_{—}10: The optimal revenue under the condition of rejecting the booking request.

Data_{—}11: A number of optimal revenues under the condition of accepting the booking requests.

Data_{—}12: A number of optimal revenues under the condition of rejecting booking requests.

Data_{—}13: A marginal profit obtained based on the difference of two average optimal revenues.

As a computer software, the booking decision method for transportation industry by sampling optimal revenue in the invention can be divided into several modules, and these modules constitute the booking decision method for transportation industry by sampling optimal revenue according to the invention. The modules are discussed as follows:

The input of Module_{—}1 is Data_{—}1, and the output thereof is Data_{—}2. Data_{—}1 is a random description of a future arrival booking request, and Data_{—}2 is a deterministic sample scenario of all future requests.

The input of Module_{—}2 is Data_{—}3, and the output thereof is Data_{—}4. Data_{—}3 is the number of current already accepted booking requests of all request classes (seat classes, price classes, service routes). Data_{—}4 is final status of the current already accepted booking requests.

The input of Module_{—}3 is Data_{—}5, and the output thereof is Data_{—}6. Data_{—}5 is a current booking request of a known booking request class (seat class, price class, service route). Data_{—}6 is the final status (cancellation status, show status, and no-show status) of the current booking request of a known request class (seat class, price class, and service route) is specified.

The input of Module_{—}4 is Data_{—}7, and the output thereof is Data_{—}8. Data_{—}7 is a current booking request with a known seat class and a known service route. Data_{—}8 is a price class and a final status of the current booking request.

The inputs of Module_{—}5 are Data_{—}2 and Data_{—}4, and the output thereof is Data_{—}10. Data_{—}10 is the optimal revenue generated by Module 5 under the condition of rejecting a booking request, when the inputs of Module_{—}5 are Data_{—}2 and Data_{—}4.

When the inputs of Module_{—}5 are Data_{—}2, Data_{—}4, and Data_{—}6, the output is Data_{—}9. Data_{—}9 is the optimal revenue generated by Module_{—}5 under the condition of accepting a booking request, when the inputs of Module_{—}5 are Data_{—}2, Data_{—}4, and Data_{—}6.

When the inputs of Module_{—}5 are Data_{—}2, Data_{—}4, and Data_{—}8, the output is Data_{—}9. Data_{—}9 is the optimal revenue generated by Module 5 under the condition of accepting a booking request, when the inputs of Module_{—}5 are Data_{—}2, Data_{—}4, and Data_{—}8.

When the inputs of Module_{—}6 are Data_{—}5, Data_{—}11, and Data_{—}12, the output is Data_{—}13, wherein Data_{—}13 is the marginal profit obtained based on a difference between two average optimal revenues.

Similarly, when the inputs of Module_{—}6 are Data_{—}7, Data_{—}11, and Data_{—}12, the output is Data_{—}13, wherein Data_{—}13 is the marginal profit obtained based on a difference between two average optimal revenues.

The aforementioned modules can be programmed by C language or other programming languages, and after being compiled into an executable file, it can be executed by the processor module 240.

After the related parameters and modules are described, the calculation procedures of a sample scenario, two average revenues and a marginal profit, and the mathematical programming model for a deterministic sample scenario are respectively discussed as follows.

A sample scenario is a complete and deterministic description of all future booking requests and events. Therefore, when a sample scenario is given, the optimal revenue can be calculated by solving the mathematical programming model. A complete sample scenario consists of the following deterministic parameters: (1) sample scenario of future booking requests: the number of future booking requests. Also, the request classes (seat classes, price classes, service routes) and the final status of each future request; (2) sample scenario of already accepted booking requests: the final status of each already accepted booking request; (3) sample scenario of current arrival booking request: the sample scenario of the current arrival booking request is the final status of the current request, if the current booking request is accepted.

The notations for the presentation of random sample scenarios are as follows:

y: sample scenario index, y=1, . . . , Y.

j: seat class, j=1, . . . , J; the smaller value of j, the higher the seat class.

p: price class, p=1, . . . , Pⱼᵤ; the smaller value of p, the higher price class. Pⱼᵤ is the number of price classes of seat class j on service route u.

l: service leg, l=1, . . . , L.

u: service route, u=1, . . . , U.

pⱼₚᵤ^{c}: the probability that an already accepted booking request of price class p of seat class j on service route u will be canceled before the departure time.

pⱼₚᵤ^{ns}: the probability that an already accepted booking request of price class p of seat class j on service route u does not show up at the departure time.

t: the current time, tε[0,T].

Y: the total number of sample scenarios.

L: the total number of service legs.

U: the total number of service routes.

T: the departure time.

Nⱼₚᵤₜ: the number of booking requests of price class p, seat class j, and service route u between the current time t and the departure time T; Nⱼₚᵤₜ is a random variable.

Vⱼₚᵤ: the cancellation time of an already accepted booking request of price class p of seat class j on service route u under the condition of the request being cancelled before the departure time; Vⱼₚᵤ is a random variable.

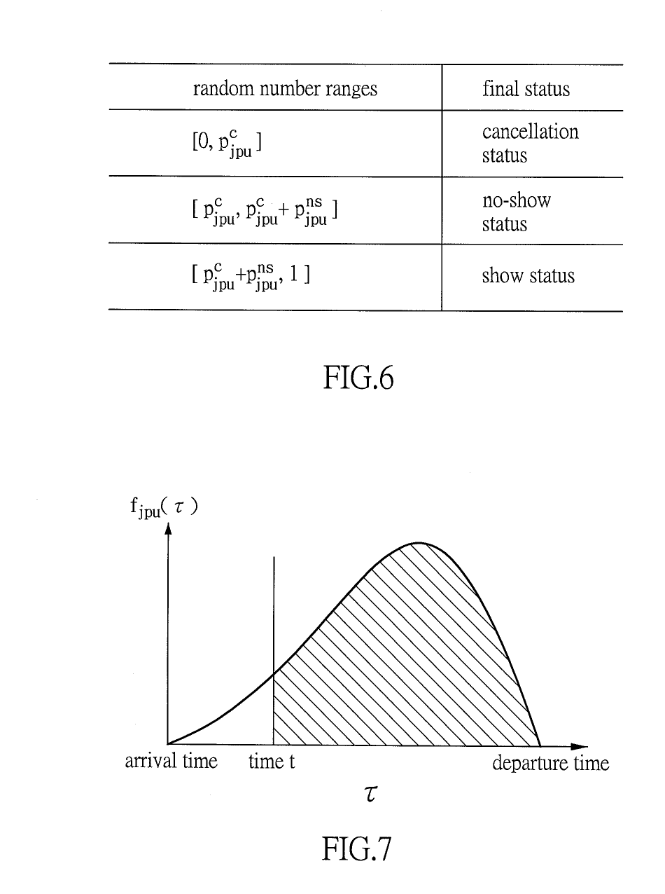

After a given time τ, the future requests can be randomly generated. A sample scenario can be generated from the assumed distributions of the number of future requests of all request classes. Different distributions can be used as the random variable of the number of future requests of a request class. Nⱼₚᵤₜ is a random variable of the number of booking requests of a booking request class (seat class j, price class p and service route u) after the current time t. With the given distribution of Nⱼₚᵤₜ, a random number of the random variable Nⱼₚᵤₜ can be generated. After having the number of booking requests, the final status of each booking request can be randomly generated with the known cancellation and no-show probabilities. That is, for each booking request, a random number between [0, 1] can be generated to specify the final status of the booking request. If the random number is between [0, pⱼₚᵤ^{c}], the final status of the booking request is cancellation status. If the random number is between [pⱼₚ^{c}, pⱼₚ^{c}+pⱼₚ^{ns}], the final status of the booking request is no-show status. Finally, if the random number is between [pⱼₚ^{c}+pⱼₚ^{ns}, 1], the final status is show status. FIG. 6 is a schematic diagram of final statuses and their corresponding random numbers according to the invention. Thus, a sample scenario for all future booking requests can be randomly generated.

The final status of an already accepted request is unknown until the request is cancelled or until the departure time. For an already accepted booking request, there are three possible final statuses of an accepted request: cancellation status, no-show status, and show status.

The first one is cancellation status. The already accepted booking request with the cancellation status will be cancelled during the request arrival time and the departure time T.

It is assumed that current time is t. For an already accepted booking request, C is the event that the booking request will be cancelled before the departure time T, N is the event that the booking request will not be cancelled before the departure time T, and B is the event that the booking request is not cancelled before t. For an accepted request which has not be cancelled before time t, the probability that the accepted request which will be cancelled before the departure time T can be obtained by:

$${P}_{t} ( C \vert B ) = \frac{P ( B \vert C ) \times P ( C )}{P ( B \vert C ) \times P ( C ) + P ( B \vert N ) \times P ( N )} .$$

Vⱼₚᵤ is a continuous random variable of the cancellation time of an already accepted booking request of price class p of seat class j on service route u that will be cancelled, and ƒⱼₚᵤ(τ) is a probability density function of Vⱼₚᵤ. FIG. 7 is a schematic diagram which is an example of the probability density function ƒⱼₚᵤ(τ) of the continuous random variable Vⱼₚᵤ. Under the condition that an accepted booking request will be cancelled, the probability that the accepted booking request will be cancelled between t and T is:

P(B|C)=P(t<Vⱼₚᵤ≦T)=∫ₜ^{T}ƒⱼₚᵤ(τ)dτ,

and the probability is the slashed area in FIG. 7.

Under the condition that an already accepted booking request will not be cancelled, the probability that the already accepted booking request will not be cancelled before time t is 1, that is, P(B|N)=1. Since events C and N are mutually exclusive events, we have P(C)+P(N)=1. Since the probability of the already accepted booking request will be cancelled before departure time T is P(C)=pⱼₚᵤ^{c}, we have P(N)=1−P(C)=1−pⱼₚᵤ^{c}.

In sum, at time t, the probability that a not-yet-cancelled request will be cancelled before the departure time T is:

$$\begin{matrix}{P}_{t} ( C \vert B ) = \frac{P ( B \vert C ) \times P ( C )}{P ( B \vert C ) \times P ( C ) + P ( B \vert N ) \times P ( N )} \\ = \frac{{\int }_{t}^{T} {f}_{jp} ( τ ) d τ \times {p}_{jp}^{c}}{{\int }_{t}^{T} {f}_{jp} ( τ ) d τ \times {p}_{jp}^{c} + 1 \times ( 1 - {p}_{jp}^{c} )} .\end{matrix}$$

The second final status of an already accepted booking request is no-show status (the customer does not show up at the departure time T). This final status is no-show status at the departure time T may result in vacant seat without profit generated. The probability of no-show status at the departure time T is pⱼₚᵤ^{ns}.

The last final status of an already accepted booking request is show status (the customer shows up at the departure time T), and the probability for the already accepted booking request which will be showed up at the time t is (1−pⱼₚᵤ^{ns}−Pₜ(C|B)).

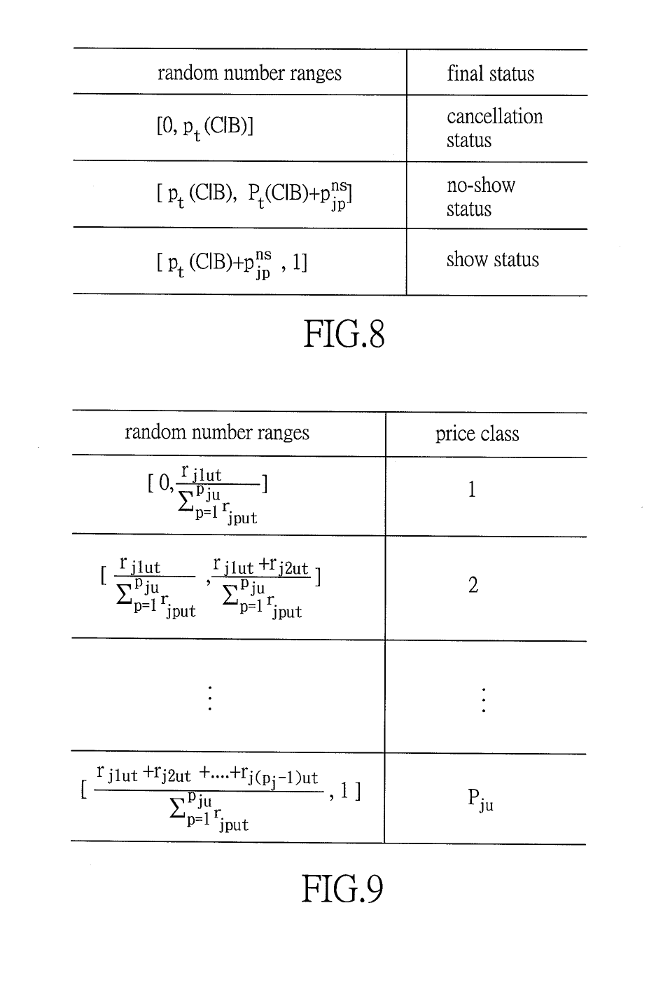

After the probabilities pⱼₚᵤ^{ns}, Pₜ(C|B), and (1−pⱼₚᵤ^{ns}−Pₜ(C|B)) of no-show status, cancellation status, and show status are given, for each already accepted customer request, a random number between [0,1] can be generated. Then, the final status of each accepted booking request in a sample scenario can be determined. If the random number is smaller than Pₜ(C|B), the final status of the accepted booking request will be cancellation status. If the random number is between [Pₜ(C|B), Pₜ(C|B)+pⱼₚᵤ^{ns}], the final status of the accepted booking request will be no-show status. If the random number is greater than Pₜ(C|B)+pⱼₚᵤ^{ns}, the final status of the accepted booking request will be show status. FIG. 8 is a schematic diagram of the final statuses of an accepted booking request and their corresponding to random number ranges. Thus, in a scenario, the final status of each accepted booking request will be generated.

For a current arrival booking request with known seat class, price class, and service route at time T, the final status of the current booking request is unknown. When the probabilities of cancellation status pⱼₚᵤ^{c}, no-show status pⱼₚᵤ^{ns}, and show status 1−pⱼₚᵤ^{c}−pⱼₚᵤ^{ns} are known, a random number between [0, 1] can be generated. Then, in a sample scenario, the final status of the current booking current request can be obtained based on corresponding random number range shown in FIG. 6.

The method discussed hereinafter is used for calculating the marginal profit of a booking request of a seat class on a service route. For a sample scenario, the price class and final status of a booking request with seat class j and service route u can be randomly generated, rⱼₚᵤₜ is an arrival rate of seat class j with price class p on service route u at time t, and Pⱼᵤ is the number of price class of seat class j on service route u. For a sample scenario, a random number between [0,1] is generated. If the random number is smaller than

$$\frac{{r}_{j 1 ut}}{{\sum }_{p = 1}^{{P}_{ju}} {r}_{jput}} ,$$

the price class of the current booking request is 1. If the random number is between

$$[ \frac{{\sum }_{p = 1}^{{p}^{′} - 1} {r}_{jput}}{{\sum }_{p = 1}^{{P}_{j}} {r}_{jput}} , \frac{{\sum }_{p = 1}^{{p}^{′}} {r}_{jput}}{{\sum }_{p = 1}^{{P}_{j}} {r}_{jput}} ] ,$$

the price class of the current booking request is p′. In a sample scenario, the price class of a current booking request can be generated in this way. FIG. 9 is a schematic diagram of the price classes of a current booking request and their corresponding random number ranges. In addition, the final status of a current request can be generated according to the probabilities of cancellation status pⱼₚᵤ^{c}, no-show status pⱼₚᵤ^{ns}, and show status 1−pⱼₚᵤ^{c}−pⱼₚᵤ^{ns}.

In transportation industries, the objective is to increase the revenue which is calculated by adding the fare of all accepted requests and subtracting the cancellation status refund, no-show status refund, and overbooking shortage penalty. Thus, the objective is to maximize the fare and minus the refund and overbooking shortage penalty. A show status booking request will bring the fare, occupy a seat, and may cause overbooking penalty, if there is no enough seats. On the other hand, the cancellation status and no-show status booking requests will bring the fare without occupying the seats and, however, result in refunds at the same time.

The optimal solution of a random sample scenario can be obtained by solving the integer programming formulation.

It is assumed that y is a sample scenario index. The current states δ of all the accepted booking requests are denoted as Data_{—}3. The parameters of the integer programming formulation are defined as follows:

sₗⱼ⁰: the initial total number of available seats of seat class j on service leg l at the beginning of reservation horizon.

ƒⱼₚᵤ is the price of price class p of seat class j on service route u.

rⱼₚᵤ^{c} is the refund for the cancellation by one seat of price class p of seat class j on service route u.

rⱼₚᵤ^{ns} is the refund for the no-show by one seat of price class p of seat class j on service route u.

rⱼₚᵤ^{s} is the shortage penalty of one seat of price class p of seat class j on service route u.

δ: the states of all currently already accepted booking requests.

δ′: the states of all currently already accepted booking requests plus the current booking requests.

W_{y}: the sample scenario y under the state δ, including the deterministic information of all future booking requests, the final statuses of all future booking requests, and the final statuses of all current already accepted booking requests.

w_{y}: the final status of a booking request which is a part of complete data in the sample scenario Y under the state δ′.

0: no booking request.

IP(W_{y},w_{y}): the integer programming formulation using the known parameters provided by booking request sample scenario y(W_{y},w_{y}).

r_{y} the optimal revenue of IP(W_{y},0) calculated under sample scenario y.

r_{y}′: the optimal revenue of IP(W_{y},w_{y}) calculated under sample scenario y.

r̅: the average revenue value of all the optimal values of IP(W_{y},0), wherein y=1, . . . Y, i.e.,

$$\overline{r} = \frac{{\sum }_{y = 1}^{Y} {r}_{y}}{Y} .$$

r̅′: the average revenue of all the optimal values of IP(W_{y}, w_{y}), y=1, . . . Y, i.e.,

$$\overline{{r}^{′}} = \frac{{\sum }_{y = 1}^{Y} {r}_{y}^{′}}{Y}$$

L̅: the set of all service legs.

Ū: the set of all service routes.

Uₗ: the set of all service routes containing service leg l.

Lᵤ: the set of all service legs that belongs to service route u.

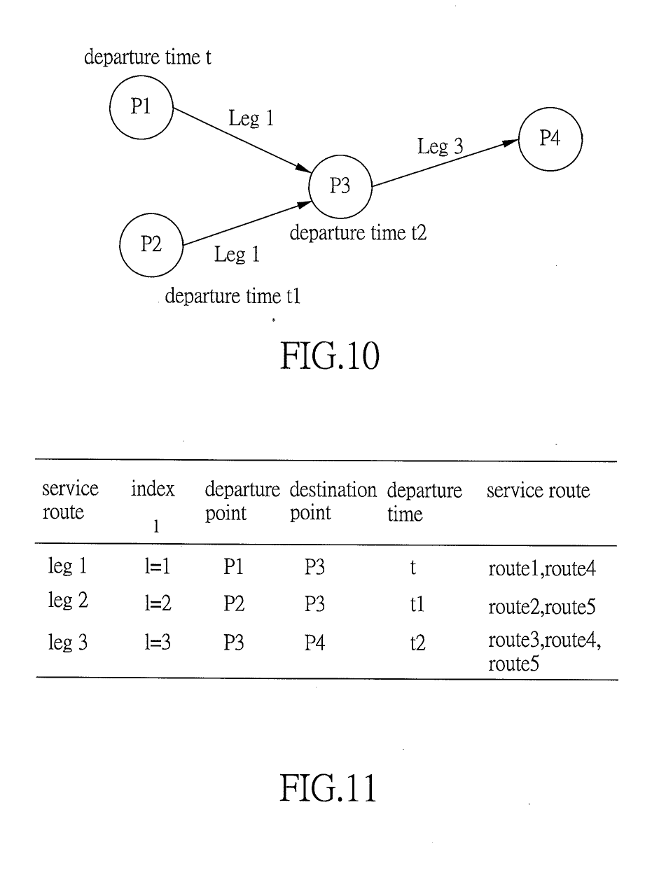

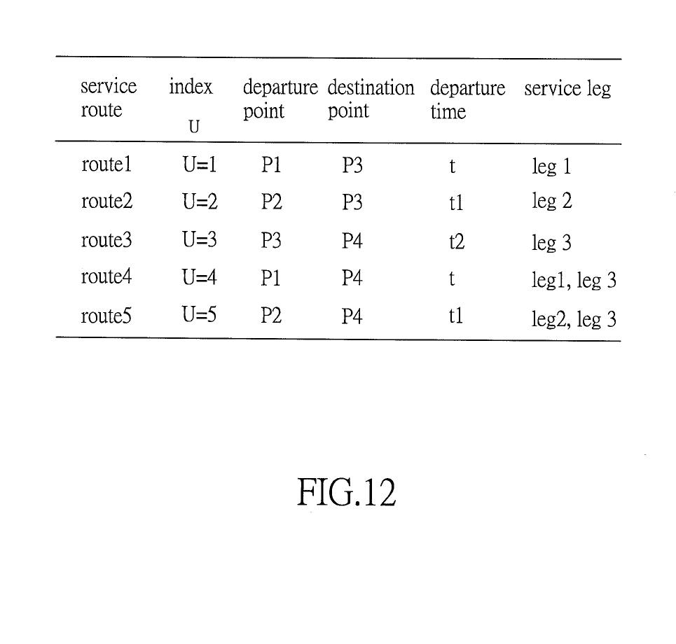

FIG. 10 is a schematic diagram of a multiple service leg according to the invention, which is used to elaborate the parameters of service routes and service legs. As shown in FIG. 10, there are four points P1, P2,P3, P4 connected by three service legs. The set of all service legs is L̅={leg 1, leg 2, leg3}. FIG. 11 is a schematic diagram of information of service legs in FIG. 10. FIG. 12 is a schematic diagram of information of service routes in FIG. 10. As shown in FIG. 12, in this embodiment, there are five service routes, and the set of all service routes is Ū={route 1, route 2, route 3, route 4, route 5}.

With the known parameters, including the final status of the booking request in a sample scenario y(w_{y}), the known final status of all future booking requests and all accepted booking requests in sample scenario y(W_{y}), the optimal revenue under the sample scenario y can be obtained by the integer programming formulation. In this embodiment, IP(W_{y},w_{y}) denotes the integer programming problem under the condition that the current booking request under the sample scenario y is accepted; IP(W_{y},0) denotes the integer programming formulation under the condition that the current booking request under the sample scenario y is rejected; r_{y} is the optimal value) of IP(W_{y},0) and r_{y}′ is the optimal value of IP(W_{y},w_{y}). After sampling Y sample scenarios and computing their corresponding optimal revenues under the condition of rejecting booking request, the average revenues under the condition of rejecting current booking request can be generated by averaging the Y optimal values. That is, the averaging revenue under the condition of rejecting booking request is

$$\overline{r} = \frac{{\sum }_{y = 1}^{Y} {r}_{y}}{Y} .$$

After sampling Y sample scenarios and computing their corresponding optimal revenues under the condition of accepting booking request, the average revenue under the condition of accepting booking request can be obtained by averaging the Y optimal values. That is, the average revenue under the condition of accepting booking request can be obtained by

$$\overline{{r}^{′}} = \frac{{\sum }_{y = 1}^{Y} {r}_{y}^{′}}{Y} .$$

The marginal profit is r̅− r̅′̅.

The integer programming formulation is discussed hereinafter. The sampling optimal revenue approach of the invention can be applied to transportation companies to improve the revenues of the companies. Each time a booking request arrives, using the method of the invention can make a decision immediately. A mathematical programming formulation can be established to optimize the seat allocations under a sample scenario that defines the complete information of all already accepted booking requests, the current booking request, and all future booking requests. Similar or equivalent mathematical formulations that are able to allocate seats to various requests in an effective way can also be adopted in this invention.

The parameters and models of the integer programming formulation are introduced as follows:

v: a final status of a booking request under a sample scenario, v is 1, 2, 3, where v=1 represents the booking request will be cancelled before the departure time, v=2 represents the booking request will be no-show status at the departure time without cancellation, and v=3 represents a booking request will be show status at the departure time.

sₗⱼ: the number of initial available seats of seat class j on service leg l.

zⱼₚᵤᵥ: the number of booking requests in class (j,p,u) with final status v of customers who arrived during the remaining booking horizon.

aⱼₚᵤᵥ: the number of already accepted booking requests in class (j,p,u) with final status v.

bⱼₚᵤᵥ: a current booking requests in class (j,p,u) with final status v.

Aⱼₚᵤᵥ: the number of booking requests in class (j,p,u) with final status v should be accepted.

Oⱼₚᵤᵥ: the number of overbooked booking requests in class (j,p,u) with final status 3.

The integer programming is under the following constraints:

$$\begin{matrix}{\sum }_{j = 1}^{{j}^{′}} [ {\sum }_{u ∈ U}^{ } {\sum }_{p = 1}^{{P}_{ju}} ( {A}_{jpu 3} + {b}_{jpu 3} - {O}_{jpu 3} ) ] \leq {\sum }_{j = 1}^{{j}^{′}} {s}_{lj} , \\ l = 1 , … , L ; \\ {j}^{′} = 1 , … , J & ( 1 ) \\ {A}_{jpuv} \leq {z}_{jpuv} + {a}_{jpuv} , \\ j = 1 , … , J ; \\ p = 1 , … , {P}_{ju} ; \\ u = 1 , … , U ; \\ v = 1 , 2 , 3 ; & ( 2 ) \\ {A}_{jpuv} \geq {a}_{jpuv} , \\ j = 1 , … , J ; \\ p = 1 , … , {P}_{ju} ; \\ u = 1 , … , U ; \\ v = 1 , 2 , 3 ; & ( 3 ) \\ {O}_{jpu 3} \leq {A}_{jpu 3} + {b}_{jpu 3} , \\ j = 1 , … , J ; \\ p = 1 , … , {P}_{ju} ; \\ u = 1 , … , U ; & ( 4 ) \\ {A}_{jpuv} \geq 0 , \\ j = 1 , … , J ; \\ p = 1 , … , {P}_{ju} ; \\ u = 1 , … , U ; \\ v = 1 , 2 , 3 ; & ( 5 ) \\ {O}_{jpu 3} \geq 0 , \\ j = 1 , … , J ; \\ p = 1 , … , {P}_{ju} ; \\ u = 1 , … , U ; & ( 6 ) \\ {A}_{jpuv} , {O}_{jpu 3} are integers , \\ j = 1 , … , J ; \\ p = 1 , … , {P}_{ju} ; \\ u = 1 , … , U ; \\ v = 1 , 2 , 3 ; & ( 7 )\end{matrix}$$

to maximize the following objective function:

$${\sum }_{j = 1}^{J} {\sum }_{u = 1}^{U} {\sum }_{p = 1}^{{P}_{ju}} [ \begin{matrix}\begin{matrix}( {f}_{jpu} - {r}_{jpu}^{c} ) {A}_{jpu 1} - {r}_{jpu}^{c} {b}_{jpu 1} + \\ ( {f}_{jpu} - {r}_{jpu}^{ns} ) {A}_{jpu 2} - {r}_{jpu}^{ns} {b}_{jpu 2} +\end{matrix} \\ {f}_{jpu} {A}_{jpu 3} - {r}_{jpu}^{s} {O}_{jpu 3}\end{matrix} ] \qquad ( 8 )$$

That is, if the complete information of all the already accepted booking requests, future booking requests, and the information of booking requests are known, the optimal seat allocations can be calculated by solving preceding integer programming model.

The objective function of formula (8) is maximizing the revenue that total fare minus the total refund of cancellation status, no-show status, and overbooking shortage penalty.

The constraint in formula (1) is:

$${\sum }_{j = 1}^{{j}^{′}} [ {\sum }_{u ∈ U}^{ } {\sum }_{p = 1}^{{P}_{ju}} ( {A}_{jpu 3} + {b}_{jpu 3} - {O}_{jpu 3} ) ] \leq {\sum }_{j = 1}^{{j}^{′}} {s}_{lj} , \\ l = 1 , … , L ; \\ {j}^{′} = 1 , … , J , \qquad ( 1 )$$

Which is a capacity restriction on the allocated booking requests with final status 3 that should be less than or equal to the available seats.

The constraint in formula (2) is:

Aⱼₚᵤᵥ≦zⱼₚᵤᵥ+aⱼₚᵤᵥ, j=1, . . . ,J; p=1, . . . ,Pⱼᵤ; u=1, . . . ,U; v=1,2,3, (2)

which represents that the optimal total number of booking requests that should be accepted is less than the sum of the number of already accepted booking requests and the number of the future booking requests.

The constraint in formula (3) is:

Aⱼₚᵤᵥ≧aⱼₚᵤᵥ, j=1, . . . ,J; p=1, . . . ,Pⱼᵤ; u=1, . . . ,U; v=1,2,3, (3)

which represents that the optimal total number of booking requests that should be accepted is not less than the number of already accepted booking requests.

The constraint in formula (4) is:

Oⱼₚᵤ₃≦Aⱼₚᵤ₃+bⱼₚᵤ₃, j=1, . . . ,J; p=1, . . . ,Pⱼᵤ; u=1, . . . ,U, (4)

which represents that the number of overbooking requests should not exceed the number of accepted booking requests plus the current booking request.

In view of the aforementioned discussion, please refer to the flowchart of the booking decision method for transportation industry by sampling optimal revenues shown in FIG. 1. At first, in step (A), it initializes a sample scenario index y to be 1. In the invention, in order to avoid the symbols from being too complicated, Y can be used as a sample scenario or a sample scenario index. It is similar to other indexes and thus a detailed description is deemed unnecessary.

In step (B), it generates the random sample scenario of the sample scenario Y. Step (B) further comprises: (B1) generating a sample scenario of a future booking request: all booking requests of various classes and their final statuses; (B2) generating sample scenarios of all accepted booking requests: final statuses; and (B3) generating a sample scenario of a current booking request: final status.

Step (B1) executes Module_{—}1 (Data_{—}1) to generate the sample scenario of the future booking request. Step (B2) executes Module_{—}2 (Data_{—}3) to generate the final statuses of the all accepted booking requests. The final statuses of the all accepted booking requests include cancellation status, no-show status, and show status. Step (B3) executes Module_{—}3 (Data_{—}5) to generate the sample scenario of the current booking request.

In step (C), it generates an optimal revenue under the condition of rejecting the current arrival booking request r_{y}, and generates an optimal revenue under the condition of accepting the current arrival booking request r_{y}′. Step (C) executes Module_{—}5 (Data_{—}2, Data_{—}4, NULL) and Module_{—}5 (Data_{—}2, Data_{—}4, Data_{—}6) to respectively generate the first optimal revenuer r_{y} and the second optimal revenue r_{y}′.

The first optimal revenue) r_{y} and the second optimal revenue r_{y}′ are calculated based on an integer programming, wherein the integer programming is employed to maximize formula (8) under the constraints of formulas (1) to (7). The detail therefor has been described hereinbefore.

In step (D), it determines whether the sample scenario index y is smaller than a total number of sample scenarios Y and, if yes, increases the sample scenario index y by 1 and then the process returns to step (B).

If the sample scenario index y is determined to be not smaller than the total number of sample scenarios Y, it calculates a first average revenue r̅ of the first optimal revenue r_{y} and a second average revenue r̅′ of the second optimal revenue r_{y}′, and further calculates a marginal profit mⱼ_{⁰}ₚ_{⁰}ᵤ_{⁰} in accordance with the first average revenue r̅ and the second average revenue r̅′, wherein the marginal profit mⱼ_{⁰}ₚ_{⁰}ᵤ_{⁰} is the first average revenue r̅ minus the second average revenue r̅′, i.e. mⱼ_{⁰}ₚ_{⁰}ᵤ_{⁰}= r̅− r̅′.

In step (F), it determines whether a price ƒⱼ_{⁰}ₚ_{⁰}ᵤ_{⁰} is bigger than the marginal profit mⱼ_{⁰}ₚ_{⁰}ᵤ_{⁰} and, if yes, accepts the current arrival booking request; otherwise, rejects the current arrival booking request.

When a current booking request arrives, the current booking request can be determined to be accepted or to be rejected in accordance with flowchart of FIG. 1.

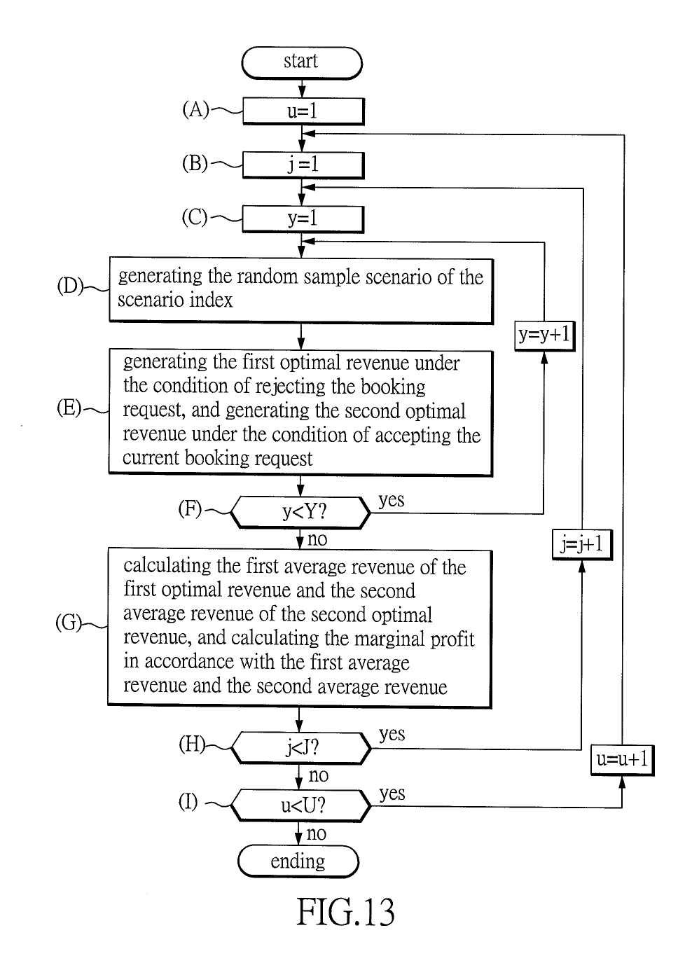

The boundary price between acceptance and rejection is the marginal profit in the flowchart of FIG. 1. In FIG. 1, the request price is known at the beginning of the flowchart. FIG. 13 is a flowchart of the booking decision method for transportation industry by sampling optimal revenues according to another embodiment of the invention. This booking decision method for transportation industry by sampling optimal revenues is executed on a computer system 200 for a transportation company. As shown in FIG. 2, the computer system 200 includes an input module 210, a database module 220, an output module 230, and a processor module 240. The input module 210 receives the arrival booking request. The database module 220 is used to store data. The processor module 240 is coupled to the input module 210, the database module 220, and the output module 230 to execute the booking decision method for transportation industry by sampling optimal revenues, and to output executed results to the output module 230 for being displayed on a display panel 250. In the flowchart of FIG. 13, the marginal profit of each seat class and each service route should be calculated before a request arrives. In addition, when a request is accepted in this application or a small time interval expires, the computation procedure has to be calculated and the marginal profit of the seat class and service route of the request has to be updated. Marginal profit of each seat class on each service route can be obtained by subtracting the expected revenue under the condition of rejecting the request of one seat by the expected revenue under the condition of accepting the request of one seat. In this embodiment, mⱼᵤ is the marginal profit of seat class j on service route u. A matrix

$${[ \begin{matrix}{m}_{11} & {m}_{12} & {m}_{13} & … & {m}_{1 U} \\ {m}_{21} & {m}_{22} & {m}_{23} & … & {m}_{2 U} \\ {m}_{31} & {m}_{32} & {m}_{33} & … & {m}_{3 U} \\ ⋮ & ⋮ & ⋮ & ⋮ & ⋮ \\ {m}_{J 1} & {m}_{J 2} & … & … & {m}_{JU}\end{matrix} ]}_{J \times U}$$

shows marginal profits of all seat classes and all service routes. A matrix element mⱼᵤ is the marginal profit of seat class j on service route u. When the booking request arrives and a price of the booking request is greater than or equal to the marginal profit mⱼᵤ, the booking request is accepted.

With reference to FIG. 13 again, in the flowchart of the booking decision method for transportation industry by sampling optimal revenues, step (A) first initializes a service route index u to be 1.

In step (B), it initializes a seat class j to be 1. In step (C), it initializes a sample scenario index y to be 1.

In step (D), it generates the random sample of the sample scenario y. Step (D) further comprises: (D1) generating a sample scenario of future booking requests: all booking requests with classes and final statuses; (D2) generating sample scenarios of all currently accepted booking requests: final statuses of all currently accepted booking requests; and (D3) generating a sample scenario of a booking request: price class and final status.

Step (D1) executes Module_{—}1 (Data_{—}1) to generate the sample scenario of all future booking requests. Step (D2) executes Module_{—}2(Data_{—}3) to generate the final statuses of all currently accepted booking requests. The final statuses of all currently accepted booking requests include cancellation status, no-show status, and show status. Step (D3) executes Module_{—}4(Data_{—}7) to generate a price class and a final status of a booking request.

In step (E), it generates an optimal revenue r_{y} under the condition of rejecting the booking request, and generates an optimal revenue r_{y}′ under the condition of accepting the booking request. It executes Module_{—}5(Data_{—}2, Data_{—}4, NULL) and Module_{—}5 (Data_{—}2, Data_{—}4, Data_{—}8) to respectively generate the first optimal revenue r_{y} and the second optimal revenue r_{y}′.

In step (F), it determines whether the sample scenario index y is smaller than a total number of sample scenarios Y and, if yes, increases the sample scenario index y by 1 and then returns to step (D).

If the sample scenario index y is determined to be not smaller than the total number of sample scenarios Y, then it executes step (G) to calculate a first average revenue r̅ of the first optimal revenue r_{y} and a second average revenue r̅′ of the second optimal revenue r_{y}′, and calculates the marginal profit mⱼᵤ according to the first average revenue r̅ and the second average revenue r̅′, wherein the marginal profit mⱼᵤ is the first average revenue r̅ minus the second average revenue r̅′, i.e., mⱼᵤ= r̅− r̅′.

In step (H), it determines whether the seat class j is smaller than the number of seat classes J and, if yes, it increases the seat class j by 1 and then the process returns to step (C).

If the seat class j is determined to be not smaller than the number of seat class J, then it determines whether the service route u is smaller than the total number of service routes U and, if yes, it increases the service route u by 1, and then the process returns to step (B); otherwise, ends the flowchart.

By executing the steps in FIG. 13, marginal profits of all seat classes on all service routes can be calculated.

When a current booking request of seat class j⁰ with price class p⁰ on service route u⁰ arrives, a price ƒⱼ_{⁰}ₚ_{⁰}ᵤ_{⁰} of seat class j⁰ with price class p⁰ on service route u⁰ can be compared with the marginal profit mⱼ_{⁰}ᵤ_{⁰}. If the price ƒⱼ_{⁰}ₚ_{⁰}ᵤ_{⁰} is smaller than the marginal profit mⱼ_{⁰}ᵤ_{⁰}, the current booking request is rejected; otherwise, the current booking request is accepted.

When the current booking request is accepted or a small predetermined time interval expires, the marginal profit matrix should be recalculated and be revised.

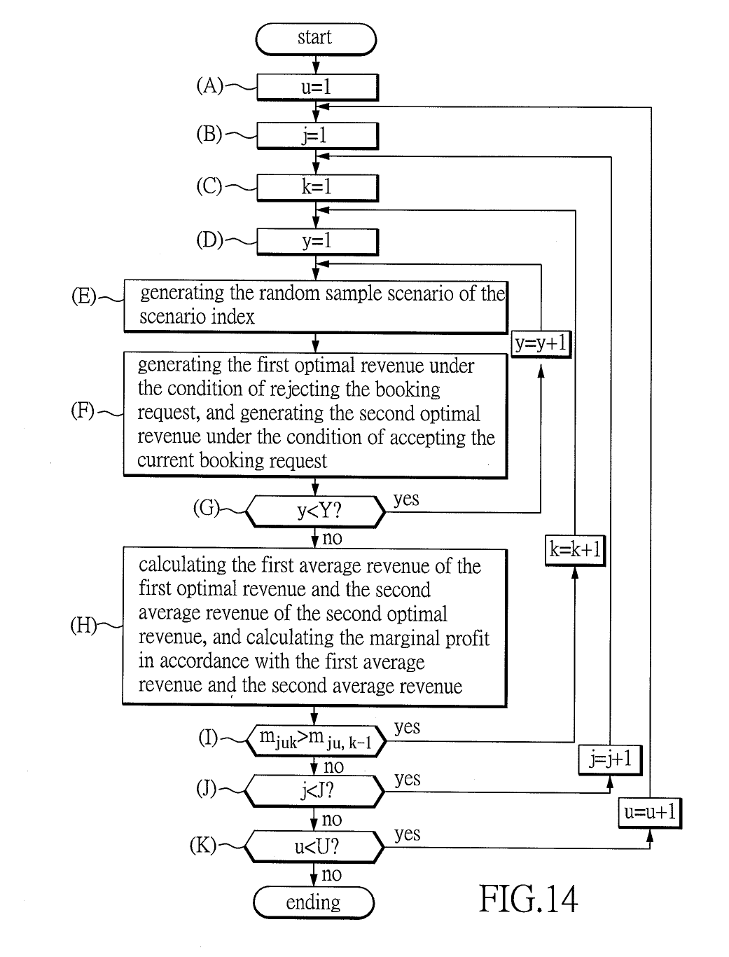

FIG. 14 is a flowchart of the booking decision method for transportation industry by sampling optimal revenue according to still another embodiment of the invention. In this embodiment, it calculates an upper reservation limit for each price class of each seat class on each service route within a small time interval, wherein t₀ is a calculated time of the flowchart of FIG. 14, and t₁ is a future time point. The time interval between t₀ and t₁ is an effective interval of the upper reservation limit calculated at t₀. In general, the length of an effective interval is smaller than the length of booking horizon of a booking request. A determination of the length of the effective interval is a trade-off decision between decision accuracy and computation time. In general, 0.5 day or 1 day is an effective interval. The future booking requests that should be considered for calculating the upper reservation limit for the effective interval are the booking requests that arrive between

$$\frac{{t}_{0} + {t}_{1}}{2}$$

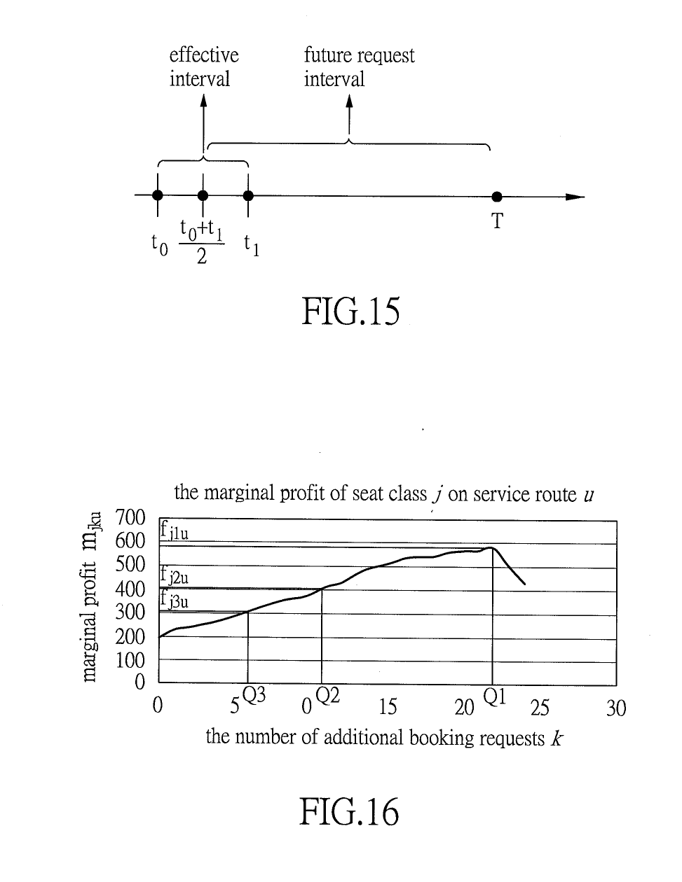

and T. FIG. 15 is a schematic diagram of time interval according to the invention, which shows the effective interval of the upper reservation limit. As shown in FIG. 15, at t₀, the upper reservation limit of an effective interval [t₀,t₁] will be calculated and, at t₁, a new upper reservation limit of a new effective interval will be recalculated.

Let k be the index for additional booking request of one seat. The k-th additional booking request is considered under the condition that k−1 seats have been already been accepted within the current effective interval. However, when calculating the marginal profit of the k-th additional booking request, the already accepted booking requests should comprise the accepted booking requests before t₀ and the booking requests of k−1 seats before the k-th additional booking request. Because the prices of the previous k−1 seats are unknown, the price of each of k−1 seats is generated by the techniques previously discussed. When k−1 new booking requests are accepted, mⱼᵤₖ is a marginal profit of the k-th additional booking request of seat class j of service route u. k̅ⱼᵤ is a minimum k satisfying mⱼᵤₖ>mⱼᵤₖ₊₁; i.e., k̅ⱼᵤ is an overbooked limit of seat class j of service route u. For k is smaller than k̅ⱼᵤ, pⱼᵤ(k) is a function mapping k into the marginal profit of seat class j of service route u. FIG. 16 is a schematic diagram of a curve line of the function pⱼᵤ(k) in the invention. The horizontal axis is the number of additional booking request k, and the vertical axis is the marginal profit mⱼᵤₖ. In this embodiment, pⱼᵤ⁻¹(m) is the inverse function of the function pⱼᵤ(k); i.e., pⱼᵤ⁻¹(m) is a function for mapping a marginal profit of seat class j of service route u into k. For a price class p of seat class j of service route U with price ƒⱼₚᵤ, a predetermined limit nⱼₚᵤ is [pⱼᵤ⁻¹(ƒⱼₚᵤ)]⁻, wherein [x]⁻ is a maximum integer that is smaller than or equal to x.

Let qⱼₚᵤ is the number of already accepted booking request within the current effective interval. When a current booking request of price class p of seat class j on service route u arrives, after adding the current booking request to the number of the already accepted booking request qⱼₚᵤ in the current effective interval, the condition Σ_{p′=p}^{P}^{ⱼᵤ}q_{jp′u}≦nⱼₚᵤ should be satisfied. If the condition cannot be satisfied, the current booking request should be rejected.

Assuming that seat class j on service route u is considered, and the price of price class 3 is 300, the price of price class 2 is 400, and the price of price class 1 is 600, the reserve limit of each price class can be shown in FIG. 16. The number of seats of accepted booking requests of price class 3 cannot be bigger than Q3. The number of seats of accepted booking requests of price classes 3 and 2 cannot be bigger than Q2. The number of seats of accepted booking requests of price classes 3, 2, and 1 cannot be bigger than Q1. Q1 is the limit of overbooking; i.e., a booking request bigger than Q1 cannot be accepted. When a current booking request arrives, the transportation company can make a real-time decision of acceptance or rejection by checking the predetermined limit of the price class of the seat class on the service route of the current booking request.

With reference to FIG. 14 again, in the flowchart of the booking decision method for transportation industry by sampling optimal revenue according to still another embodiment of the invention, step (A) first initializes a service route index u to be 1.

In step (B), it initializes a seat class j to be 1. In step (C), it initializes the index k for additional booking request of one seat to be 1. In step (D), it initializes a sample scenario index y to be 1.

In step (E), it generates a random sample of the sample scenario Y. Step (E) further comprises: (E1) generating a sample scenario of all future booking requests; (E2) generating the final statuses of all currently accepted booking requests; (E3) generating a sample scenario of a booking request: price class and final status.

Step (E1) executes Module_{—}1 (Data_{—}1) to generate the sample scenario of all future booking requests. Step (E2) executes Module_{—}2 (Data_{—}3) to generate the final statuses of all currently accepted booking requests. The final statuses of all currently accepted booking requests include cancellation status, no-show status, and show-up status. Step (E3) executes Module_{—}4(Data_{—}7) to generate the price class and the final status of a booking request.

In step (F), it generates an optimal revenue r_{y} under the condition of rejecting the booking request, and generates an optimal revenue r_{y}′ under the condition of accepting the booking request. It executes Module_{—}5 (Data_{—}2, Data_{—}4, NULL) and Module_{—}5 (Data_{—}2, Data_{—}4, Data_{—}8) to respectively generate the first optimal revenue r_{y} and the second optimal revenue r_{y}′.

In step (G), it determines whether the sample scenario index y is smaller than a total number of sample scenarios Y and, if yes, increases the sample scenario index y by 1, and then the process returns to step (E).

If the sample scenario index y is determined not to be smaller than the total number of sample scenarios Y, then it calculates the first average revenuer r̅ of the first optimal revenue r_{y} and the second average revenue r̅′ of the second average revenue r_{y}′ in step (H) and, according to the first average revenue r̅ and the second average revenue r̅′, calculates the marginal profit mⱼᵤₖ, wherein the marginal profit mⱼᵤₖ is the first average revenue r̅ minus the second average revenue r̅′, i.e., mⱼᵤₖ= r̅− r̅′.

In step (I), it determines whether the marginal profit is smaller than a previous marginal profit mⱼᵤₖ₋₁ and, if no, it increases the additional booking request index k of the seat by 1, and then the process returns to step (D).

When the marginal profit mⱼᵤₖ is determined to be smaller than the previous marginal profit mⱼᵤₖ₋₁ in step (I), then it determines whether the seat class j is smaller than a number of seat class J and, if yes, it increases the seat class j by 1, and then the process returns to step (C).

If the seat class j is determined to be not smaller than the number of seat class J in step (J), it further determines whether the service route u is smaller than a total number of service routes U in step (K) and, if yes, it increases the service route u by 1, and the process returns to step (B); otherwise, the flowchart ends. With the steps in FIG. 14, marginal profits of all additional booking requests of all seat classes on all service routes can be calculated.

In view of the foregoing, it is known that the invention can be applied to bookings of airline companies, bus companies, railway companies . . . etc. When applying the invention into the situation that a transportation company has limited resources, such as the restriction in the number of seats, and the booking requests arrive in a random process, the decision maker of the company can determine whether to accept or reject the booking requests to maximize profits of the company.

Although the present invention has been explained in relation to its preferred embodiment, it is to be understood that many other possible modifications and variations can be made without departing from the spirit and scope of the invention as hereinafter claimed.

What is claimed is:

1. A booking decision method for transportation industry by sampling optimal revenues, which is executed on a computer system for a transportation company to accept or reject a current arrival booking request based on a marginal profit. The computer system includes an input module, a database module, an output module, and a processor module, the input module receiving the current arrival booking request, the database module being used to store data, the processor module being coupled to the input module, the database module, the output module, and the processor module to execute the booking decision method for transportation industry by sampling optimal revenues, and to output executed result to the output module, the method comprising the steps of:
(A) the processor module initializing a sample scenario index (y=1);
(B) the processor module generating a random sample scenario of scenario index y;
(C) the processor module generating a first optimal revenue r_{y} under a condition of rejecting the current arrival booking request, and generating a second optimal revenue r_{y}′ under a condition of accepting the current arrival booking request;
(D) the processor determining whether the sample scenario index is smaller than a total number of sample scenarios Y and, if yes, increasing the sample scenario index by one and then returning to step (B);
(E) if the sample scenario index is determined to be not smaller than the total number of sample scenarios Y in step (D), calculating a first average revenue r̅ of the first optimal revenue r_{y} and a second average revenue r̅′ of the second optimal revenue Y, and calculating the marginal profit mⱼ_{⁰}ₚ_{⁰}ᵤ_{⁰} according to the first average revenue and the second average revenue; and
(F) the processor module determining whether a price is greater than or equal to the marginal profit and, if yes, the processor module accepting the current arrival booking request, otherwise, rejecting the current arrival booking request.

2. The booking decision method for transportation industry by sampling optimal revenues as claimed in claim 1, wherein step (B) further comprises the steps of:
(B1) the processor module generating sample scenarios of all future booking requests;
(B2) the processor module generating sample scenarios of all accepted booking requests; and
(B3) generates a sample scenario of a current booking request.

3. The booking decision method for transportation industry by sampling optimal revenues as claimed in claim 2, wherein the marginal profit mⱼ_{⁰}ₚ_{⁰}ᵤ_{⁰} is equal to the first average revenuer minus the second average revenue r̅′ (mⱼ_{⁰}ₚ_{⁰}ᵤ_{⁰}= r̅− r̅′).

4. The booking decision method for transportation industry by sampling optimal revenues as claimed in claim 3, wherein each of all accepted booking requests has a final status which can be a cancellation status, a no-show status, or a show status.

5. The booking decision method for transportation industry by sampling optimal revenues as claimed in claim 4, wherein the first optimal revenue r_{y} and the second optimal revenue r_{y}′ are computed by an integer programming.

6. The booking decision method for transportation industry by sampling optimal revenues as claimed in claim 5, wherein the integer programming is optimized under the following constraints:
$$\begin{matrix}{\sum }_{j = 1}^{{j}^{′}} [ {\sum }_{u ∈ U}^{ } {\sum }_{p = 1}^{{P}_{ju}} ( {A}_{jpu 3} + {b}_{jpu 3} - {O}_{jpu 3} ) ] \leq {\sum }_{j = 1}^{{j}^{′}} {s}_{lj} , \\ l = 1 , … , L ; \\ {j}^{′} = 1 , … , J ; \\ {A}_{jpuv} \leq {z}_{jpuv} + {a}_{jpuv} , \\ j = 1 , … , J ; \\ p = 1 , … , {P}_{ju} ; \\ u = 1 , … , U ; \\ v = 1 , 2 , 3 ; \\ {A}_{jpuv} \geq {a}_{jpuv} , \\ j = 1 , … , J ; \\ p = 1 , … , {P}_{ju} ; \\ u = 1 , … , U ; \\ v = 1 , 2 , 3 ; \\ {O}_{jpu 3} \leq {A}_{jpu 3} + {b}_{jpu 3} , \\ j = 1 , … , J ; \\ p = 1 , … , {P}_{ju} ; \\ u = 1 , … , U ; \\ {A}_{jpuv} \geq 0 , \\ j = 1 , … , J ; \\ p = 1 , … , {P}_{ju} ; \\ u = 1 , … , U ; \\ v = 1 , 2 , 3 ; \\ {O}_{jpu 3} \geq 0 , \\ j = 1 , … , J ; \\ p = 1 , … , {P}_{ju} ; \\ u = 1 , … , U ; \\ {A}_{jpuv} , {O}_{jpu 3} are integers , \\ j = 1 , … , J ; \\ p = 1 , … , {P}_{ju} ; \\ u = 1 , … , U ; \\ v = 1 , 2 , 3 ;\end{matrix}$$
for maximizing the following objective function:
Σⱼ₌₁^{J}Σᵤ₌₁^{U}Σₚ₌₁^{P}^{ⱼᵤ}[(ƒⱼₚᵤ−rⱼₚᵤ^{c})Aⱼₚᵤ₁−rⱼₚᵤ^{c}bⱼₚᵤ₁+(ƒⱼₚᵤ−rⱼₚᵤ^{ns})Aⱼₚᵤ₂−rⱼₚᵤ^{ns}bⱼₚᵤ₂+ƒⱼₚᵤAⱼₚᵤ₃−rⱼₚᵤ^{s}Oⱼₚᵤ₃],
where j is a seat class; J is a number of seat class; p is a price class; Pⱼᵤ is a number price class for seat class j on service route u; it is a service route index; v is a final status; aⱼₚᵤᵥ is a number of already accepted booking requests in class (j,p,u) with final status v; bⱼₚᵤᵥ is a booking request in class (j,p,u) with final status v that is accepted; zⱼₚᵤᵥ is a number of booking requests in class (j,p,u) with final status v that arrive during the remaining booking horizon; Aⱼₚᵤᵥ is a number of booking requests in class (j,p,u) with final status v should be accepted; Oⱼₚᵤ₃ is a number of overbooked accepted requests in class (j,p,u) with final status 3; ƒⱼₚᵤ is a price of price class p of seat class j on service route u; rⱼₚᵤ^{c} is a refund for the cancellation by one seat of price class p of seat class j on service route u; rⱼₚᵤ^{ns} is a refund for the no-show by one seat of price class p of seat class j on service route u; rⱼₚᵤ^{s} is a shortage penalty of one seat of price class p of seat class j on service route u.

7. The booking decision method for transportation industry by sampling optimal revenues as claimed in claim 6, wherein the constraint of:
$${\sum }_{j = 1}^{{j}^{′}} [ {\sum }_{u ∈ {U}_{l}}^{ } {\sum }_{p = 1}^{{P}_{ju}} ( {A}_{jpu 3} + {b}_{jpu 3} + {O}_{jpu 3} ) ] \leq {\sum }_{j = 1}^{{j}^{′}} {s}_{lj} , \\ l = 1 , … , L ;$$
$${j}^{′} = 1 , … , J ;$$
is a capacity constraint in which only the booking requests with final status v=3 (show-up) are considered for allocation of available seats.

8. The booking decision method for transportation industry by sampling optimal revenues as claimed in claim 7, wherein, the constraint of:
Aⱼₚᵤᵥ≦zⱼₚᵤᵥ+aⱼₚᵤᵥ, j=1, . . . ,J; p=1, . . . ,Pⱼᵤ; u=1, . . . ,U; v=1,2,3;
indicates that the total number of accepted booking requests should be less than the number of already accepted booking requests and the number of the future booking requests.

9. The booking decision method for transportation industry by sampling optimal revenues as claimed in claim 8, wherein the constraint of:
Aⱼₚᵤᵥ≧aⱼₚᵤᵥ, j=1, . . . ,J; p=1, . . . ,Pⱼᵤ; u=1, . . . ,U; v=1,2,3;
indicates that the total accepted booking requests optimized in a current scenario should not be less than the already accepted booking requests.

10. The booking decision method for transportation industry by sampling optimal revenues as claimed in claim 8, wherein, the constraint of:
Oⱼₚᵤ₃≦Aⱼₚᵤ₃+bⱼₚᵤ₃, j=1, . . . ,J; p=1, . . . ,Pⱼᵤ; u=1, . . . ,U;
indicates that the overbooked booking requests should not excess the number of accepted booking requests plus the current booking request.

11. A booking decision method for transportation industry by sampling optimal revenues, which is executed on a computer system for a transportation company, the computer system including an input module, a database module, an output module, and a processor module, the input module receiving an arrival booking request, the database module being used to store data, the processor being coupled to the input module, the database module and the output module to execute the booking decision method for transportation industry by sampling optimal revenues, and to output executed result to the output module, the method comprising the steps of:
(A) the processor module initializing a service route index (u−1);
(B) the processor module initializing a seat class (j=1);
(C) the processor module initializing a sample scenario index (y=1);
(D) the processor module generating a random sample scenario of the sample scenario index y;
(E) the processor module generating a first optimal revenue r_{y} under a condition of rejecting the booking request, and generating a second optimal revenue r_{y}′ under a condition of accepting the current booking request;
(F) the processor module determining whether the sample scenario index y is smaller than a total number of sample scenarios Y and, if yes, increasing the sample scenario index by 1, and then returning to step (D);
(G) if the sample scenario index is determined to be not smaller than the total number of sample scenarios in step (F), the processor module calculating a first average revenue r̅ of the first optimal revenue r_{y} and a second average revenue r̅′ of the second optimal revenue r_{y}′, and further calculating a marginal profit mⱼᵤ in accordance with the first average revenuer r̅ and the second average revenue r̅′;
(H) the processor module determining whether the seat class j is smaller than a number of seat class J and, if yes, increasing the seat class j by 1 and then returning to step (C); and
(I) if the seat class j is determined to be not smaller than the number of seat class J in step (H), the processor module then determining whether the service route index u is smaller than a total number of service routes U and, if yes, increasing the service route index u by 1, and returning to step (B).

12. The booking decision method for transportation industry by sampling optimal revenues as claimed in claim 11, wherein the step (D) further comprises the steps of:
(D1) the processor module generating a sample scenario of all future booking requests;
(D2) the processor module generating a sample scenario of all accepted booking requests; and
(D3) the processor module generating a sample scenario of a current booking request.

13. The booking decision method for transportation industry by sampling optimal revenues as claimed in claim 12, wherein the marginal profit mⱼᵤ is equal to the first average revenue r̅ minus the second average revenue r̅′ (mⱼᵤ= r̅− r̅′).

14. The booking decision method for transportation industry by sampling optimal revenues as claimed in claim 13, wherein the processor accepts a booking request only when the booking request arrives and the price of the booking request is greater than or equal to the marginal profit mⱼᵤ.

15. A booking decision method for transportation industry by sampling optimal revenues, which is executed on a computer system for a transportation company, the computer system including an input module, a database module, an output module, and a processor module, the input module receiving an arrival booking request, the database module being used to store data, the processor being coupled to the input module, the database module, and the output module to execute the booking decision method for transportation industry by sampling optimal revenues, and to output executed result to the output module, the method comprising the steps of:
(A) the processor module initializing a service route index u=1;
(B) the processor module initializing a seat class j=1;
(C) the processor module initializing an index k=1 for additional booking request of one seat;
(D) the processor module initializing a sample scenario index y=1;
(E) the processor module generating a random sample scenario of the scenario index y;
(F) the processor module generating a first optimal revenue r_{y} under a condition of rejecting the booking request and generating a second optimal revenue r_{y}′ under a condition of accepting the booking request;
(G) the processor module determining whether the sample scenario index is smaller than a total number of sample scenarios Y and, if yes, the processor module increasing the sample scenario by 1, and returning to step (E);
(H) if the sample scenario index is determined to be not smaller than the total number of sample scenarios Y in step (G), the processor module calculating a first average revenue r̅ of the first optimal revenue r_{y} and a second average revenue r̅′ of the second optimal revenue r_{y}′, and further calculating a marginal profit mⱼᵤₖ in accordance with the first average revenue r̅ and the second average revenue r̅′;
(I) the processor module determining whether the marginal profit mⱼᵤₖ is smaller than a previous marginal profit m_{ju,k-1} and, if no, the processor module increasing the index k for additional booking request of one seat by 1, and returning to step (D);
(J) if the marginal profit mⱼᵤₖ is determined to be smaller than the previous marginal profit m_{ju,k-1} in step (I), the processor module then determining whether the seat class j is smaller than a number of seat class J and, if yes, the processor module increasing the seat class j by 1, and returning to step (C); and
(K) if the seat class j is determined to be not smaller than the number of seat class J in step (J), the processor module then determining whether the service route index u is smaller than a total number of service routes U and, if yes, the processor module increasing the service route index u by 1, and returning to step (B).

16. The booking decision method for transportation industry by sampling optimal revenues as claimed in claim 15, wherein the step (E) further comprises the steps of:
(E1) the processor module generating a sample scenario of all future booking requests;
(E2) the processor module generating sample scenarios of all accepted booking requests; and
(E3) the processor module generates a sample scenario of a current booking request.

17. The booking decision method for transportation industry by sampling optimal revenues as claimed in claim 16, wherein the marginal profit is equal to the first average revenue r̅ minus the second average revenue r̅′ (mⱼᵤₖ= r̅− r̅′).
